(19) United States
(12) Patent Application Publication
(10) Pub. No.: US 2012/0085459 A1
(43) Pub. Date: Apr. 12, 2012

(54) SYSTEM FOR FUELING RAIL SYSTEM FUEL TENDER

(76) Inventors: Paul NICHINI, Lansdale, PA (US); Ross Rowland, Sackets Harbor, NY (US)

(21) Appl. No.: 12/899,723

(22) Filed: Oct. 7, 2010

(51) Int. Cl. B67D 7/02

(52) U.S. Cl. 141/98

(57) ABSTRACT

A system for fueling a rail system fuel tender which comprises a chassis and one or more fuel containers, with each fuel container adapted to contain a quantity of pressurized fuel, where the system comprises a fuel source storage facility located distant from the fuel tender, a fuel delivery means for conveying fuel from the fuel source storage facility to the fuel tender, and a fuel filling means for placing pressurized fuel into the fuel tender.

### BACKGROUND OF THE INVENTION

1. Technical Field

The invention relates generally to the field of railroad fueling systems. More specifically, the invention is directed to an improved system for fueling rail system fuel tenders adapted to run on railroad rails as part of a train comprising at least one locomotive for which the improved fuel tender provides fuel.

2. Description of Prior Art

Railroad fuel tenders are well known in the art. From the earliest coal cars which were coupled to steam locomotive engines to the diesel tankers used more recently, separate vehicles have been employed to transport the fuel used by the locomotives powering trains. While locomotives have traditionally been fueled by oil or diesel, the use of natural gas is increasing. Natural gas is a cleaner burning fuel than oil or diesel and is less costly in many markets, making it an attractive alternative fuel. It may be used in the form of compressed natural gas or liquid natural gas. Engines that operate on hydrogen fuel are also known. All of these environmentally sustainable fuel types are used under pressure.

Improved fuel tenders that are adapted to fuel locomotives which run on pressurized fuel, for example, the improved rail system fuel tender disclosed in U.S. patent application Ser. No. 12/899,670 (Oct. 7, 2010, to Nichini, et al.), which Applicant hereby incorporates by reference in its entirety, have unique fueling needs as compared with traditional fuel tenders carrying non-pressurized fuel. While fuel tenders carrying oil or diesel may be fueled directly from tanks located at a rail yard, fuel tenders carrying pressurized fuel cannot be fueled directly from storage tanks, which typically contain low pressure fuel, but rather the fuel must first be pressurized before the fuel tender can be refueled. There is therefore a need for an improved system for fueling rail system fuel tenders which carry pressurized fuel.

It is therefore an objective of the present invention to provide an improved system for fueling rail system fuel tenders which carry pressurized fuel.

It is a further objective of the present invention to provide an improved system for fueling rail system fuel tenders which provides flexible means for delivering fuel from a distant fuel storage location to the rail yard.

It is yet a further objective of the present invention to provide an improved system for fueling rail system fuel tenders which provides flexible means for delivering fuel into the fuel tender.

It is yet a further objective of the present invention to provide an improved system for fueling rail system fuel tenders which provides a means for delivering fuel to fuel tenders having independently installable and removable fuel containers.

Other objects of the present invention will be readily apparent from the description that follows.

### SUMMARY OF THE INVENTION

The improved system for fueling a rail system fuel tender of the present invention is adapted to provide fuel to an improved fuel tender having one or more fuel containers, each fuel container being adapted to contain a quantity of pressurized fuel.

In one embodiment the system comprises a fuel source storage facility located distant from the fuel tender. In this embodiment the system further comprises a fuel delivery means adapted to convey fuel from the fuel source storage facility to the fuel tender, and a fuel filling means that is adapted to place fuel into the fuel tender. The fuel delivery means may be a low or a high pressure fuel pipeline or an over the road fuel tanker truck. In such embodiments the fuel filling means may further comprise a compressor means to pressurize the fuel prior to refueling the fuel tender, if needed. In yet another embodiment the fuel filling means comprises a plurality of cascade storage tanks, with each cascade storage tank coupled with a compressor such that pressurized fuel is transferred from the cascade storage tanks to the fuel tender. In an alternate variant, the fuel delivery means comprises multiple high pressure cylinders, which are placed onto an over the road truck and transported to the fuel tender. In this embodiment the fuel source storage facility comprises a plurality of cascade storage tanks, with each cascade storage tank coupled with a compressor such that pressurized fuel is transferred from the cascade storage tanks to the multiple high pressure cylinders. The fuel filling means is a device, such as a crane, that can place the high pressure cylinders onto the fuel tender.

In another embodiment the system comprises a fuel source storage facility located distant from the fuel tender and a fuel destination storage facility located proximate to the fuel tender. In this embodiment the system further comprises a fuel delivery means adapted to convey fuel from the fuel source storage facility to the fuel destination storage facility, and a fuel filling means that is adapted to place fuel from the fuel destination storage facility into the fuel tender. The fuel delivery means may be a low pressure fuel pipeline or an over the road fuel tanker truck. In such embodiments the fuel filling means must further comprise a compressor means to pressurize the fuel from the fuel destination storage facility prior to refueling the fuel tender. In the preferred embodiment the fuel filling means comprises a plurality of cascade storage tanks, with each cascade storage tank coupled with a compressor such that pressurized fuel is transferred from the cascade storage tanks to the fuel tender. The fuel filling means may further comprise a refueling manifold adapted to deliver pressurized fuel from the cascade storage tanks to multiple high pressure cylinders located on the fuel tender.

In yet another embodiment the system comprises a fuel storage facility located proximate to the fuel tender. In this embodiment the system further comprises a fuel filling means that is adapted to place fuel from the fuel storage facility into the fuel tender. In such embodiments the fuel filling means must further comprise a compressor means to pressurize the fuel from the fuel storage facility prior to refueling the fuel tender. In the preferred embodiment fuel filling means comprises a plurality of cascade storage tanks, with each cascade storage tank coupled with a compressor such that pressurized fuel is transferred from the cascade storage tanks via a refueling manifold into a plurality of high pressure cylinders carried by the fuel tender.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims incorporated herein.

### DESCRIPTION OF THE DRAWINGS

FIG. 1 is a plan side view of the fuel tender of the improved system for fueling a rail system fuel tender.

FIG. 2 is a schematic depiction of one embodiment of the improved system for fueling a rail system fuel tender of the present invention whereby the fuel delivery means is a low pressure pipeline.

FIG. 3 is a schematic depiction of another embodiment of the improved system for fueling a rail system fuel tender of the present invention whereby the fuel delivery means is an over the road tanker truck.

FIG. 4 is a schematic depiction of yet another embodiment of the improved system for fueling a rail system fuel tender of the present invention whereby the fuel delivery means is an over the road truck capable of transporting multiple high pressure cylinders, and the fuel filling means is a crane capable of lifting the high pressure cylinders from the truck and onto the fuel tender.

FIG. 5 is a schematic depiction of one embodiment of the improved system for fueling a rail system fuel tender of the present invention whereby the fuel delivery means is a low pressure pipeline which delivers fuel from a distant fuel source storage facility to a fuel destination storage facility proximate to the fuel tender.

FIG. 6 is a schematic depiction of another embodiment of the improved system for fueling a rail system fuel tender of the present invention whereby the fuel delivery means is an over the road tanker truck which delivers fuel from a distant fuel source storage facility to a fuel destination storage facility proximate to the fuel tender.

FIG. 7 is a schematic depiction of yet another embodiment of the improved system for fueling a rail system fuel tender of the present invention whereby the fuel storage facility is located proximate to the fuel tender and the fuel filling means is adapted to place pressurized fuel via a refueling manifold into multiple high pressure cylinders located on the fuel tender.

### DETAILED DESCRIPTION OF THE INVENTION

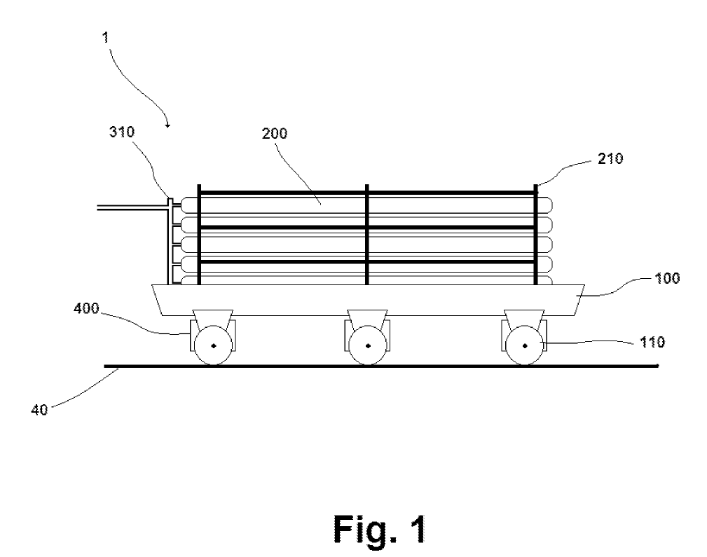

The present invention discloses an improved system for fueling a rail system fuel tender 1, where the fuel tender 1 is adapted to fuel locomotives having engines which run on pressurized fuel, such as compressed natural gas, liquid natural gas, propane, natural gas, hydrogen, and the like. Such fuel tenders 1 comprise a chassis 100 having integrated therewith at least two pairs of wheels 110 suitably adapted to allow the fuel tender 1 to engage with and move about railroad rails 40, and one or more fuel containers 200, each fuel container 200 being suitably adapted to contain a quantity of pressurized fuel. See FIG. 1. In the preferred embodiments each of the fuel containers 200 is a high pressure cylinder suitably adapted to contain fuel pressurized to at least 1000 psi and as much as 5000 psi. In the most preferred embodiments the cylinders 200 may contain fuel pressurized to between 3200 psi and 3600 psi. An example of such a fuel cylinder 200 is the 3AAX-2900 made by FIBA Technologies, Inc. The use of standardized fuel cylinders 200 allows for lower costs, as well as compliance with Department of Transportation regulations and over-the-road transportation capabilities. However, any type of fuel container 200 may be used, provided it is capable of containing pressurized fuel.

The fuel tender 1 may further comprise a refueling manifold 310. See FIG. 1. The refueling manifold 310 is in connection with each of the plurality of containers 200 and is suitably adapted to allow each of the fuel containers 200 to be filled with fuel. In one embodiment the refueling manifold 310 allows the fuel containers 200 to be filled in sequence, each fuel container 200 being filled with fuel independently of each other fuel container 200; in another embodiment the refueling manifold 310 allows multiple fuel containers 200 to be filled simultaneously. The refueling manifold 310 is configured using piping, valving, conduits, and the like as is well known in the art. In yet another embodiment multiple refueling manifolds 310 may be used, with each refueling manifold 310 being in connection with only some of the fuel containers 200. For example, a fuel tender 1 having forty fuel containers 200 may have twenty of the fuel containers 200 in connection with one refueling manifold 310 and the remaining twenty fuel containers 200 in connection with another refueling manifold 310. In this embodiment, the aggregate of the refueling manifolds 310 is in connection with the aggregate of the fuel containers 200. Multiple refueling manifolds 310 allow for a “cascade” or group refueling, decreasing the time needed to refuel a fuel tender 1.

The fuel tender 1 may also comprise a propulsion mechanism 400, with the propulsion mechanism 400 integrated with the chassis 100 and capable of propelling the fuel tender 1. See FIG. 1. In one embodiment the propulsion mechanism 400 comprises one or more electric motors. In the preferred embodiment the one or more electric motors of the propulsion mechanism 400 are traction motors capable of driving the wheels 110 of the chassis 100. Alternatively, the fuel tender 1 may be unpowered.

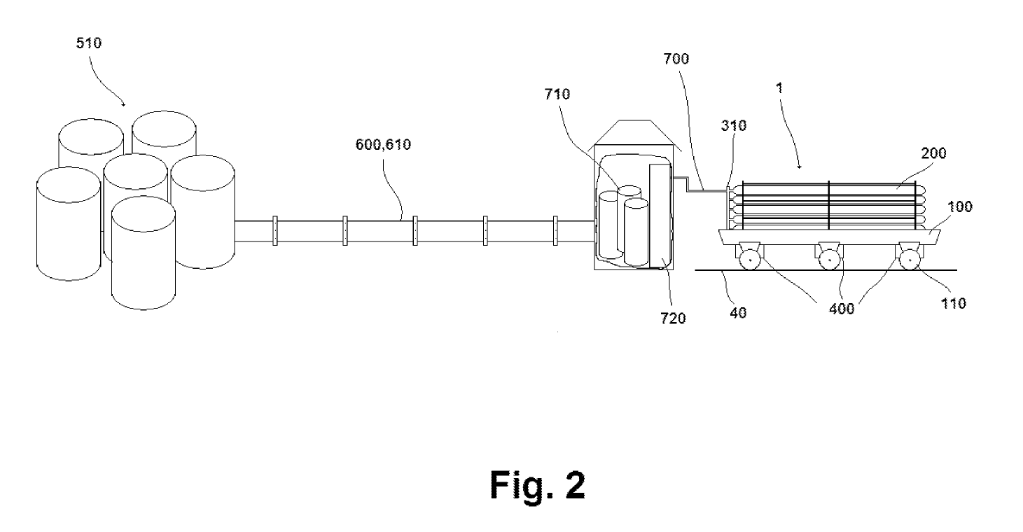

In one embodiment, the improved system for fueling a rail system fuel tender 1 of the present invention comprises a fuel source storage facility 510, a fuel delivery means 600, and a fuel filling means 700. See FIGS. 2, 3, and 4.

In this embodiment the fuel source storage facility 510 is located distant from the fuel tender 1 and is suitably adapted to store a quantity of fuel. The fuel source storage facility 510 is typically a centralized tank farm which is located near a fuel source, such as a liquid natural gas terminal or pipeline. The fuel tanks typically store fuel in a state of lower pressure than will be used by the fuel tender 1. The fuel source storage facility 510 may be used to provide fuel to multiple different locations, each of which may be used to fuel the fuel tenders 1. An example may be a single fuel source storage facility 510 which provides fuel to various rail yards in a given region.

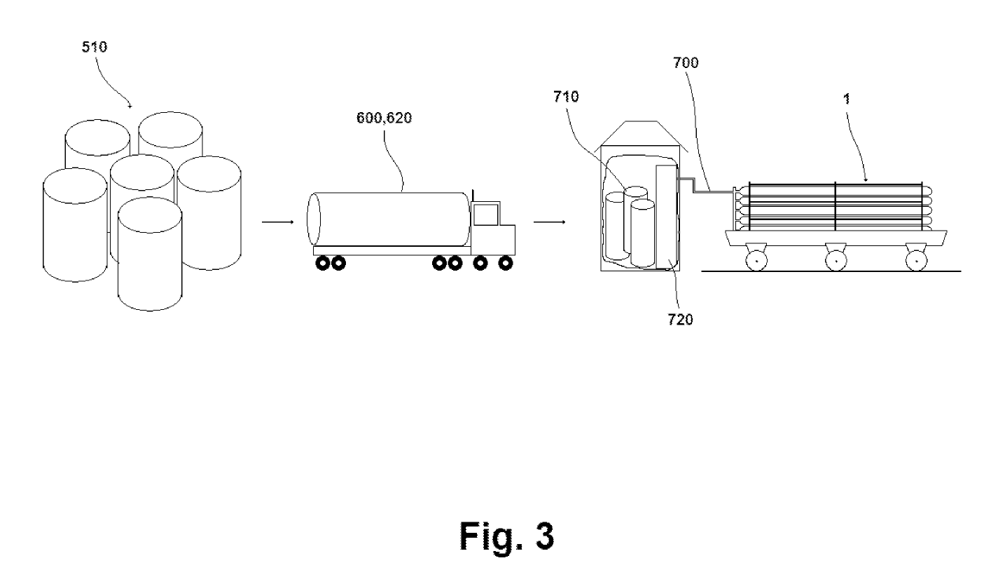

The fuel delivery means 600 is any means suitably adapted to convey fuel from the fuel source storage facility 510 to the location of the fuel tender 1. In one embodiment the fuel delivery means 600 is a low pressure pipeline 610. See FIG. 2. In another embodiment the fuel delivery means 600 is a high pressure pipeline. In yet another embodiment the fuel delivery means 600 is an over the road tank truck 620. See FIG. 3. Other means known in the art are also contemplated for transporting fuel from the fuel source storage facility 510 to the location of the fuel tender 1.

The fuel filling means 700 is adapted to place fuel into the fuel tender 1. The fuel filling means 700 may comprise piping, hoses, or any other appropriate means known in the art. The fuel filling means 700 may be adapted to interface with one or more refueling manifolds 310 of the fuel tender 1.

Because the fuel may be delivered by the fuel delivery means 600 at a lower pressure than is to be used by the fuel tender 1, the fuel filling means 700 may comprise a compressor means to pressurize the fuel prior to placing it onto the fuel tender 1. This may be a compressor station suitably adapted to pressurize the fuel. Alternatively, the fuel filling means 700 may comprise a plurality of cascade storage tanks 710, with each cascade storage tank 710 coupled with a compressor 720 such that pressurized fuel is transferred from the cascade storage tanks 710 to the fuel containers 200. See FIGS. 2 and 3. The compressor means may also be located at the fuel source storage facility 510 and used, for example, to pressurize the fuel that is loaded into an over the road tank truck 620, which then transports high pressure fuel to the location of the fuel tender 1.

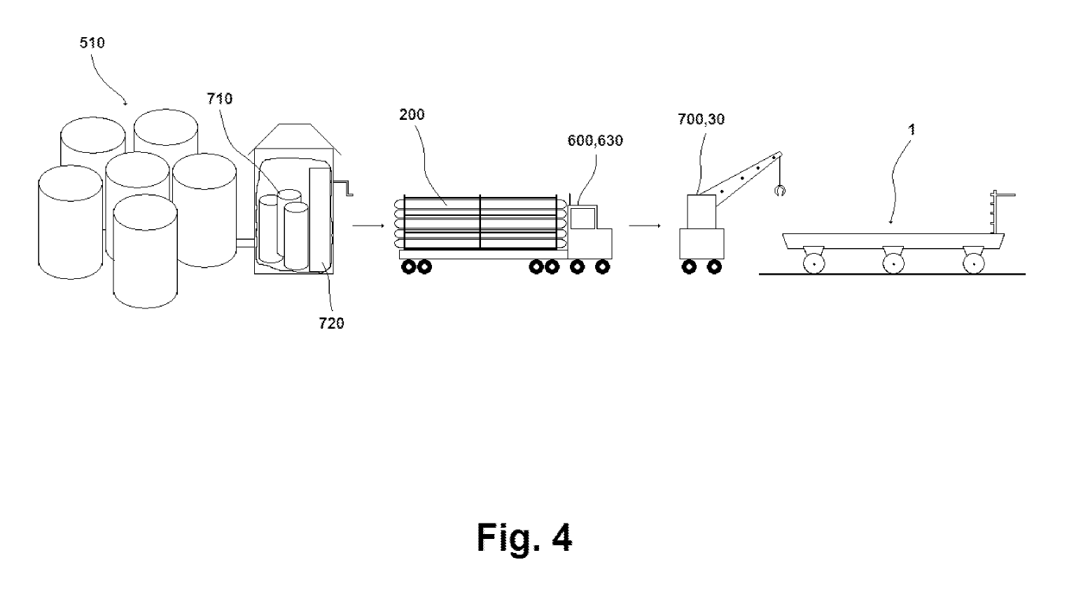

In an alternative embodiment, the fuel containers 200 of the fuel tender 1 are removable from and installable onto the fuel tender 1. In this embodiment the fuel containers 200 are preferably high pressure cylinders. The fuel delivery means 600 comprises a plurality of the fuel containers 200 and an over the road truck 630 suitably adapted to transport the fuel containers 200. The fuel containers 200 are fueled at the fuel source storage facility 510 with pressurized fuel, placed on the truck 630, and transported to the location of the fuel tender 1. See FIG. 4. In one embodiment the fuel containers 200 are assembled onto a fuel frame 210. The fuel frame 210 should be constructed of rigid members, such as structural steel beams, thereby providing not only support for the fuel containers 200 but also a protective superstructure. The fuel frame 210 is installable onto and removable from the fuel tender 1 without need for disassembly of the chassis 100 of the fuel tender 1, such that the fuel containers 200 and fuel frame 210 operate as a single unit. In a variant of this embodiment, there may be multiple fuel frames 210, each containing a subset of the total number of fuel containers 200. The fuel frames 210 may be stacked one onto another on the tender chassis 100. In these embodiments, the fuel filling means 700 comprises one or more devices, such as a crane 30 or a forklift, adapted to remove the fuel containers 200 or the one or more fuel frames 210 from the truck 630 and to place the fuel containers 200 or the one or more fuel frames 210 onto the fuel tender 1. In order to fuel the fuel containers 200, the fuel source storage facility 510 utilizes a compressor station suitably adapted to pressurize the fuel. Alternatively, the fuel source storage facility 510 may comprise a plurality of cascade storage tanks 710, with each cascade storage tank 710 coupled with a compressor 720 such that pressurized fuel is transferred from the cascade storage tanks 710 to the fuel containers 200. This alternative embodiment is useful in situations where there is little or no infrastructure for transporting fuel from the fuel source storage facility 510 to the fuel tender 1, or where the fuel tender 1 refueling site itself has little infrastructure. This allows fuel tenders 1 to be refueled at remote locations, thereby extending the train's range.

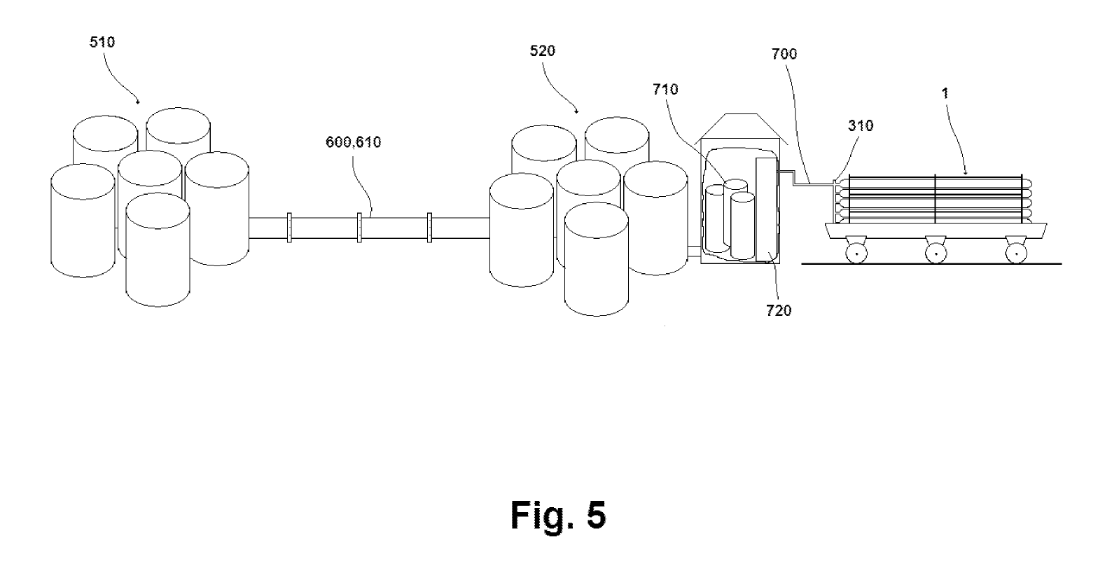

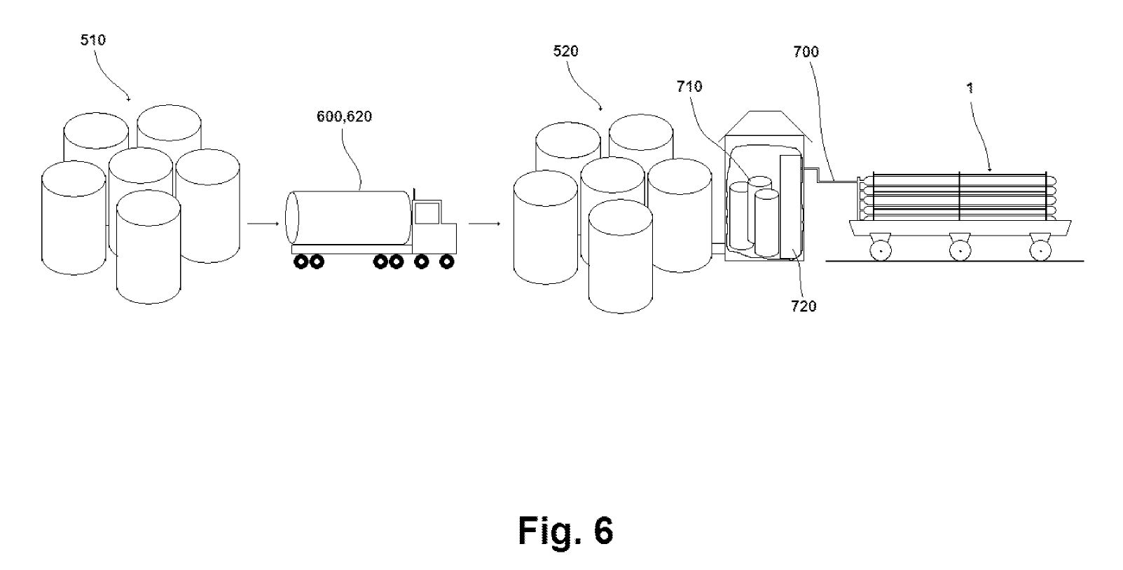

In another embodiment of the improved system for fueling a rail system fuel tender 1, the system further comprises a fuel destination storage facility 520 adapted to store a quantity of fuel, in addition to the fuel source storage facility 510, the fuel delivery means 600, and the fuel filling means 700, as described above. See FIGS. 5 and 6. In this embodiment the fuel destination storage facility 520 is located proximate to the fuel tender 1. The fuel destination storage facility 520 is typically a centralized tank farm. The fuel tanks typically store fuel in a state of lower pressure than will be used by the fuel tender 1. The fuel destination storage facility 520 is typically located within a rail yard. The fuel delivery means 600 in this embodiment is suitably adapted to convey fuel from the fuel source storage facility 510 to the fuel destination storage facility 520, and may be a high or low pressure pipeline 610, see FIG. 5, an over the road tank truck 620, see FIG. 6, or other means known in the art for transporting fuel from the fuel source storage facility 510 to the fuel destination storage facility 520. The fuel filling means 700 is adapted to place fuel from the fuel destination storage facility 520 into the fuel tender 1, as described above.

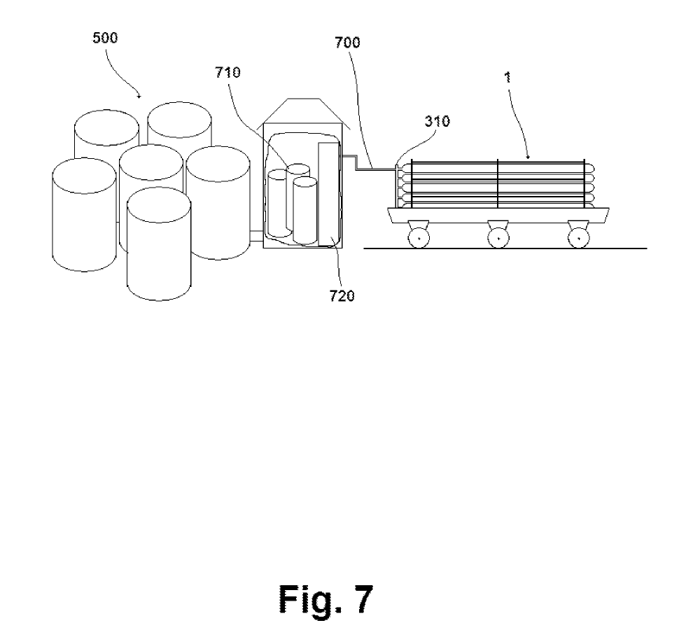

In yet another embodiment, the improved system for fueling a rail system fuel tender 1 of the present invention comprises a fuel storage facility 500 and a fuel filling means 700. See FIG. 7. In this embodiment the fuel storage facility 500 is adapted to store a quantity of fuel and is located proximate to the fuel tender 1. The fuel filling means 700 is adapted to place fuel from the fuel storage facility 500 into the fuel tender 1, as described above.

What has been described and illustrated herein is a preferred embodiment of the invention along with some it its variations. The terms, descriptions and figures used herein are set forth by way of illustration only and are not meant as limitations. Those skilled in the art will recognize that many variations are possible within the spirit and scope of the invention as defined in the following claims in which all terms are meant in their broadest, reasonable sense unless otherwise indicated.

I claim:

1. A system for fueling a rail system fuel tender, said fuel tender comprising a chassis, said chassis having integrated therewith at least two pairs of wheels suitably adapted to allow the fuel tender to engage with and move about railroad rails, said fuel tender further comprising one or more fuel containers, each said fuel container suitably adapted to contain a quantity of fuel,
said system comprising:
a fuel source storage facility, said fuel source storage facility suitably adapted to store a quantity of fuel, said fuel source storage facility being located distant from said fuel tender;
a fuel delivery means, said fuel delivery means suitably adapted to convey fuel from the fuel source storage facility to the fuel tender; and
a fuel filling means, said fuel filling means suitably adapted to place fuel from the fuel delivery means into the fuel tender.

2. The system of claim 1 wherein the fuel to be contained within each said fuel container comprises one of the following group: compressed natural gas, liquid natural gas, propane, natural gas, and hydrogen.

3. The system of claim 1 wherein said fuel tender further comprises a powered propulsion mechanism, said propulsion mechanism capable of propelling said fuel tender.

4. The system of claim 1 wherein the fuel tender comprises a refueling manifold, said refueling manifold being in connection with each of said one or more fuel containers,
wherein the fuel filling means is in connection with said refueling manifold.

5. The system of claim 1 wherein the fuel delivery means is a pipeline.

6. The system of claim 1 wherein the fuel delivery means is a tank truck.

7. The system of claim 1 wherein the fuel filling means comprises a compressor station suitably adapted to pressurize said fuel.

8. The system of claim 1 wherein the fuel filling means comprises a plurality of cascade storage tanks, with each said cascade storage tank coupled with a compressor such that pressurized fuel is transferred from the cascade storage tanks to the one or more fuel containers.

9. The system of claim 1 wherein the fuel source storage facility comprises a compressor station suitably adapted to pressurize said fuel.

10. The system of claim 1 wherein the fuel source storage facility comprises a plurality of cascade storage tanks, with each said cascade storage tank coupled with a compressor such that pressurized fuel is transferred from the cascade storage tanks to the one or more fuel containers.

11. The system of claim 1 wherein the fuel delivery means comprises a plurality of said fuel containers and a truck suitably adapted to transport said fuel containers.

12. The system of claim 11 wherein the fuel source storage facility comprises a compressor station suitably adapted to pressurize said fuel.

13. The system of claim 11 wherein the fuel source storage facility comprises a plurality of cascade storage tanks, with each said cascade storage tank coupled with a compressor such that pressurized fuel is transferred from the cascade storage tanks to the plurality of fuel containers.

14. The system of claim 11 wherein the fuel filling means comprises one or more devices suitably adapted to remove said fuel containers from said truck and to place said fuel containers onto said fuel tender.

15. The system of claim 11 wherein the fuel filling means comprises a crane suitably adapted to remove said fuel containers from said truck and to place said fuel containers onto said fuel tender.

16. The system of claim 1 further comprising a fuel destination storage facility, said fuel destination storage facility suitably adapted to store a quantity of fuel, said fuel destination storage facility being located proximate to said fuel tender;
wherein said fuel delivery means is suitably adapted to convey fuel from the fuel source storage facility to the fuel destination storage facility, and
said fuel filling means is suitably adapted to place fuel from the fuel destination storage facility into the fuel tender.

17. The system of claim 16 wherein the fuel delivery means is a pipeline.

18. The system of claim 16 wherein the fuel delivery means is a tank truck.

19. The system of claim 16 wherein the fuel source storage facility comprises a compressor station suitably adapted to pressurize said fuel.

20. The system of claim 16 wherein the fuel source storage facility comprises a plurality of cascade storage tanks, with each said cascade storage tank coupled with a compressor such that pressurized fuel is transferred from the cascade storage tanks to the fuel delivery means.

21. The system of claim 16 wherein the fuel tender comprises a refueling manifold, said refueling manifold being in connection with each of said one or more fuel containers,
wherein the fuel filling means is in connection with said fuel destination storage facility and with said refueling manifold.

22. The system of claim 16 wherein the fuel destination storage facility comprises a compressor station suitably adapted to pressurize said fuel.

23. The system of claim 22 wherein the fuel filling means is suitably adapted to place pressurized fuel from the fuel destination storage facility into the one or more fuel containers.

24. The system of claim 23 wherein the fuel tender comprises a refueling manifold, said refueling manifold being in connection with each of said one or more fuel containers,
wherein the fuel filling means is in connection with said fuel destination storage facility and with said refueling manifold.

25. The system of claim 16 wherein the fuel destination storage facility comprises a plurality of cascade storage tanks, with each said cascade storage tank coupled with a compressor such that pressurized fuel is transferred from the cascade storage tanks to the one or more fuel containers.

26. The system of claim 25 wherein the fuel filling means is suitably adapted to place pressurized fuel from the fuel destination storage facility into the one or more fuel containers.

27. The system of claim 26 wherein the fuel tender comprises a refueling manifold, said refueling manifold being in connection with each of said one or more fuel containers,
wherein the fuel filling means is in connection with said fuel destination storage facility and with said refueling manifold.

28. A system for fueling a rail system fuel tender, said fuel tender comprising a chassis, said chassis having integrated therewith at least two pairs of wheels suitably adapted to allow the fuel tender to engage with and move about railroad rails, said fuel tender further comprising one or more fuel containers, each said fuel container suitably adapted to contain a quantity of fuel, said system comprising:
a fuel storage facility, said fuel storage facility suitably adapted to store a quantity of fuel, said fuel storage facility being located proximate to said fuel tender; and
a fuel filling means, said fuel filling means suitably adapted to place fuel from the fuel storage facility into the fuel tender.

29. The system of claim 28 wherein the fuel tender comprises a refueling manifold, said refueling manifold being in connection with each of said one or more fuel containers,
wherein the fuel filling means is in connection with said fuel storage facility and with said refueling manifold.

30. The system of claim 28 wherein the fuel storage facility comprises a compressor station suitably adapted to pressurize said fuel.

31. The system of claim 30 wherein the fuel filling means is suitably adapted to place pressurized fuel from the fuel storage facility into said one or more fuel containers.

32. The system of claim 31 wherein the fuel tender comprises a refueling manifold, said refueling manifold being in connection with each of said one or more fuel containers,
wherein the fuel filling means is in connection with said fuel storage facility and with said refueling manifold.

33. The system of claim 28 wherein the fuel storage facility comprises a plurality of cascade storage tanks, with each said cascade storage tank coupled with a compressor such that pressurized fuel is transferred from the cascade storage tanks to the one or more fuel containers.

34. The system of claim 33 wherein the fuel filling means is suitably adapted to place pressurized fuel from the fuel storage facility into said one or more fuel containers.

35. The system of claim 34 wherein the fuel tender comprises a refueling manifold, said refueling manifold being in connection with each of said one or more fuel containers,
wherein the fuel filling means is in connection with said fuel storage facility and with said refueling manifold.

36. The system of claim 28 wherein the fuel to be contained within each said fuel container comprises one of the following group: compressed natural gas, liquid natural gas, propane, natural gas, and hydrogen.

37. The system of claim 28 wherein said fuel tender further comprises a powered propulsion mechanism, said propulsion mechanism capable of propelling said fuel tender.

38. A system for fueling a rail system fuel tender, said fuel tender comprising a chassis, said chassis having integrated therewith at least two pairs of wheels suitably adapted to allow the fuel tender to engage with and move about railroad rails, said fuel tender further comprising a plurality of fuel containers, each said fuel container suitably adapted to contain a quantity of pressurized fuel, each fuel container being a high pressure cylinder suitably adapted to contain fuel pressurized to at least 1000 psi;
said system comprising:
a fuel storage facility, said fuel storage facility suitably adapted to store a quantity of fuel, said fuel storage facility being located proximate to said fuel tender, said fuel storage facility comprising a plurality of cascade storage tanks, with each said cascade storage tank coupled with a compressor such that pressurized fuel is transferred from the cascade storage tanks to the one or more fuel containers; and
a fuel filling means, said fuel filling means comprising a refueling manifold, said refueling manifold being in connection with each of said plurality of fuel containers, wherein said fuel filling means is suitably adapted to place pressurized fuel from the fuel storage facility into the plurality of fuel containers through the refueling manifold;
whereby the fuel to be contained within each said fuel container comprises one of the following group: compressed natural gas, liquid natural gas, propane, natural gas, and hydrogen.
